(19) United States
(12) Patent Application Publication
(10) Pub. No.: US 2007/0195151 A1
(43) Pub. Date: Aug. 23, 2007

(54) Hand-held ink jet pen

(76) Inventors: Frank Edward Anderson, Sadieville, KY (US); Sam Norasak, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/360,878

(22) Filed: Feb. 23, 2006

(51) Int. Cl. B41J 3/36

(52) U.S. Cl. 347/109

(57) ABSTRACT

Hand-held ink jet pen having an ink reservoir, a printhead and a power source. The ink jet pen having a surface contact sensor and an override jetting button. The surface contact sensor provides a signal to the printhead when the printhead is in close proximity to or in contact with the substrate. The override jetting button provides ejection of ink regardless of the signal of the surface contact sensor. Hand-held ink jet pen having a removable printhead cap. Printhead cap has an absorbent pad adapted for maintenance of the printhead.

### TECHNICAL FIELD

The present invention relates to a hand-held ink jet pen, and more specifically to a unique ink jet pen having improved maintenance and jetting capabilities.

### BACKGROUND OF THE INVENTION

Ink jet printing is a conventional technique by which printing is accomplished without contact between the printing apparatus and the substrate, or medium, on which the desired print characters are deposited. Such printing is accomplished by ejecting ink from an ink jet printhead of the printing apparatus via numerous methods which employ, for example, pressurized nozzles, electrostatic fields, piezo-electric elements and/or heaters for vapor phase droplet formation.

Recently there has been a desire for a hand-held printer, which utilizes the same ink jet printing technology. One embodiment of this hand-held printer is an ink jet pen. The ink jet pen utilizes a printhead to deposit ink on a substrate rather than utilizing a conventional ballpoint roller or felt tip marker of a conventional pen. A user of the ink jet pen activates the pen typically by placing the ink jet pen in contact with or close proximity to a substrate. The typical ink jet pen has one or more sensors adapted to determine when the pen is in contact with or in a predetermined proximity to the substrate. To write using the ink jet pen, the user moves the ink jet pen in a similar motion as a user would move a conventional pen to deposit ink on the substrate. It is desired that the ink jet pen be similar in shape and/or size to a conventional pen to allow the user to efficiently and effectively use the ink jet pen for writing. Accordingly, the conventional components of ink jet printing must be miniaturized to fit in the conventional long and slender shape of a pen.

As mentioned above, in a typical hand-held ink jet pen, the printhead must be in contact with or close proximity to the substrate in order to eject ink. This feature is typically required to prevent ink from ejecting from the hand-held pen during non-use time, such as when stored in a shirt pocket, drawer, purse, etc. In some situations, it would be desirous to be able to use the hand-held ink jet pen in a manner similar to an air brush in which the ink jet pen will eject ink even though the printhead is not in contact or within a predetermined proximity of the substrate.

In conventional ink jet printers, most printers perform maintenance on the printheads as the need should arise. This maintenance may include wiping the nozzles of the printhead to remove any excess ink, checking nozzle alignment, etc. For example, the printer driver or printer firmware may clean the printheads by jetting ink or wiping the nozzles of the printhead. Some conventional printers employ a maintenance station in the printer to conduct such activities. However, due to the desired size and shape of the hand-held ink jet pen, conventional maintenance stations are ineffective and would require additional space.

As such, there is a need for ink jet pens with an overriding jetting button and a printhead cover with maintenance features. Accordingly, improved ink jet pens are desired.

### SUMMARY OF THE INVENTION

The present invention relates to ink jet pens having a printhead cover and an overriding jetting button. One aspect of the present invention is an ink jet pen. The ink jet pen comprises an ink reservoir adapted to contain ink; a printhead in fluid communication with the ink reservoir; and a power source. The ink jet pen further comprise a surface contact sensor, wherein the surface contact sensor is configured to send a signal to the printhead to allow ejection of ink when the surface contact sensor is in contact with a surface. The hand-held ink jet pen further comprises an override jetting button. The jetting button is configured to allow ejection of ink from the ink jet pen without surface contact of the surface contact senor.

Another aspect of the present invention is an ink jet pen. The ink jet pen comprises an ink reservoir adapted to contain ink; a printhead in fluid communication with the ink reservoir; a power source; and a surface contact sensor, wherein the surface contact sensor is configured to send a signal to the printhead to allow ejection of ink when the surface contact sensor is in contact with a surface. The hand-held ink jet pen further comprises a removable printhead cap. The printhead cap is configured to cover at least a portion of the printhead of the ink jet pen.

The ink jet pens of the present invention are advantageous for providing ink jet pens having increased printhead maintenance and jetting capabilities. These and additional advantages will be apparent in view of the detailed description.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic illustration of an exemplary ink jet pen according to a first embodiment of the present invention;

FIG. 2 is a schematic illustration of an exemplary ink jet pen according to a second embodiment of the present invention; and

FIG. 3 is a schematic illustration of an exemplary ink jet pen according to a third embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments which are illustrated in the accompanying drawings, wherein like numerals indicate similar elements throughout the views.

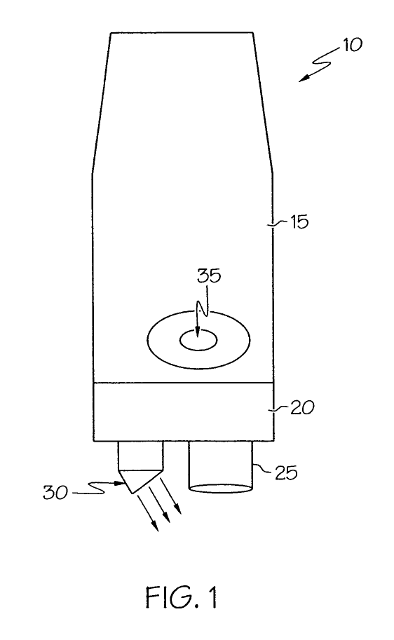

One embodiment of the present invention is illustrated in FIG. 1. In this embodiment, the ink jet pen 10 comprises an ink reservoir 15 adapted to contain ink. The ink jet pen 10 further comprises a printhead 30 in fluid communication with the ink reservoir 15. The ink jet pen 10 also comprises a surface contact sensor 25, wherein the surface contact sensor is configured to send a signal to the printhead to allow ejection of ink when the surface contact sensor is in contact with or close proximity to a surface. The ink jet pen 10 further comprises an override jetting button 35. The override jetting button 35 is configured to allow ejection of ink from the ink jet pen 10 without a signal from the surface contact sensor 25. In another exemplary embodiment, the override jetting button 35 is further adapted to control the flow rate of ink ejected from the ink jet pen 10.

One of ordinary skill will recognize that various embodiments involving an override button 35 can be used with the present invention. In one embodiment, for example, an override button 35 causes the pen 10 to freely emit ink, either intermittently or in a continuous stream, until the button 10 is deactivated. In such an embodiment, the ink jet pen 10 serves as a type of blow pen.

In some embodiments, the override button 35 only comes into play after a predetermined signal is received from one or both of the contact and movement sensors. In such case, the compression rate for the firing frequency of the pen 10 may be added to a normal firing frequency, as an override, when the override button 35 is activated. In alternative embodiments, an override button 35 may be configured as a slider, or other adjustable control, which modifies the firing frequency as the button 35 (or slider) is moved from one position to another.

In one exemplary embodiment, the surface contact sensor 25 is in communication with a power source 20, wherein the power source 20 is configured to activate the printhead 30 when the surface contact sensor 25 detects movement along the surface of a substrate. In another embodiment, the printhead 30 is configured to deliver jetting ink to the substrate near the surface contact sensor 25.

In one exemplary embodiment, the ink reservoir 15 may comprise one or more chambers and wherein at least one of the chambers may be filled with a negative pressure producing material. Exemplary negative pressure producing material include felts and polymer foams that are well known to one of ordinary skill in the art, such as P.E.T. fibers having a density of 0.170 g/cc, available from manufacturers such as Transorb Wicks™.

In one exemplary embodiment of the present invention, the ink reservoir 15 is removable from the ink jet pen 10. For example, ink reservoirs 15 can be replaced in the ink jet pen 10 to allow replacement ink or different colors or types of ink to be jetted by the ink jet pen 10.

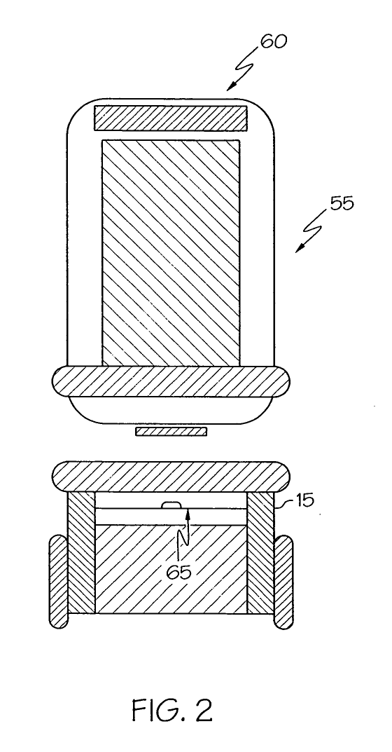

In another exemplary embodiment, illustrated in FIG. 2, the ink reservoir 15 is adapted to connect to an auxiliary ink tank 55. The auxiliary ink tank 55 is adapted to contain ink and could allow additional quantities of ink to be utilized by the ink jet pen 10. In this embodiment, the ink reservoir 15 may or may not be replaceable. For example, the ink reservoir 15 may not be replaceable but additional ink quantities can be added to the pen utilizing the auxiliary ink tank 55. For example, in one embodiment, the auxiliary ink tank 55 is adapted to connect to the ink reservoir 15 such that the auxiliary ink tank 55 is in fluid communication with the ink reservoir 15. In one exemplary embodiment, the auxiliary ink tank 55 further comprises a power source 60. In another exemplary embodiment of the present invention, the ink reservoir 15 comprises a seal 65, wherein the seal 65 is adapted to receive the auxiliary ink tank 55 and provide fluid communication between the auxiliary ink tank 55 and the ink reservoir 15.

In another exemplary embodiment, the ink jet pen 10 further comprises a housing, wherein the housing is adapted to contain at least a portion of the power source and the ink reservoir. In yet another exemplary embodiment, the ink reservoir 15 further comprises an ink sensor adapted to alert a user of ink quantity remaining in the ink reservoir. Such ink sensors are known in the art and typically use reflected light to determine whether ink remains in the reservoir. In a condition when ink is present, the sensor reflects a greater percentage of light. In an ink not present condition, less light is reflected. The difference in reflected light is a measurable quantity and can be used to determine whether ink is present in a reservoir.

In an alternative embodiment, some or all of the housing that holds the ink may be made of a transparent or semi-transparent material that allows a user to visually detect the presence or absence of ink in the reservoir.

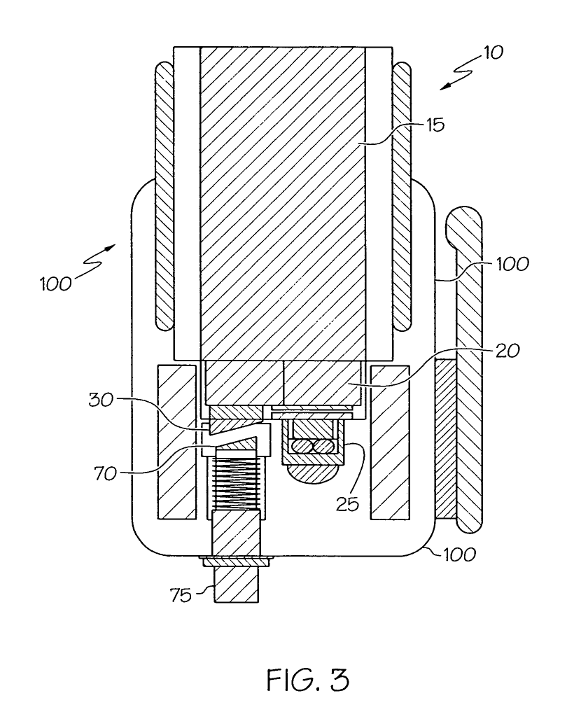

Another exemplary embodiment of the present invention is illustrated in FIG. 3. In this embodiment, the hand-held ink jet pen 10 further comprises a cap 100. The cap 100 is configured to cover at least a portion of the ink jet pen 10. In one exemplary embodiment, the cap 100 is configured to cover at least a portion of the printhead 30 of the ink jet pen 10. The cap 100 is configured to provide protection to the printhead 30 from damage or other contamination when the ink jet pen 10 is not in use. In one exemplary embodiment, the cap 100 is configured in a manner similar to a conventional cap for a ball point pen, with the possible exception of the cap 100 being sized to cover at least a portion of the printhead 30.

In another exemplary embodiment, the cap 100 further comprises an absorbent pad 70. The absorbent pad is configured to be in communication with the printhead and to perform maintenance on the printhead. For example, the absorbent pad 70 may be utilized to wipe the printhead nozzles to perform maintenance on the printhead. In another exemplary embodiment, the printhead cap 100 further comprises an actuator 75 adapted to place the absorbent pad 70 in contact with the printhead 30 when the cap 100 is on the ink jet pen 10 and the actuator is actuated. For purposes of ease of description, the actuator 75 is described as a spring actuator, but one of ordinary skill in the art will understand that various types of mechanical and electro-mechanical actuators can serve the functions attributed to the spring actuator 75.

In operation, the spring actuator 75 works akin to the spring actuator of a ball point pen and can be actuated by a thumb or other suitable surface. During the capping process, the absorbent pads 70 are pressed against the printhead nozzle area and performs maintenance function on the nozzles when the pen is capped and the actuator 75 is pressed.

In one exemplary embodiment of the present invention, the surface contact sensor 25 comprises a ballpoint roller. In another exemplary embodiment, the ballpoint roller is in contact with a ballpoint sensor switch which is adapted to detect movement of the ballpoint contact sensor along a substrate. Upon such detection of movement, the sensor switch is adapted to send a signal to the power source and/or printhead, wherein jetting from the ink jet nozzles of the printhead can begin. In another embodiment of the present invention, the surface contact device 25 further comprises a pressure switch, wherein the pressure switch is adapted to determine the amount of force placed on the surface contact device by the user. The pressure sensor is connected to the power source and printhead. In one exemplary embodiment, the more force exerted by the user on the surface contact device 25, the frequency of the ink being jetting from the ink jet pen is increased.

In one exemplary embodiment, the power source 20 is located on or in the ink reservoir 15. In one embodiment, electrical contacts can run from the ink reservoir 15 and the power source 20 to the printhead and other devices requiring power from the power source 20. Placement of the power source 20 on the ink reservoir 15 allows for easy replacement of the power source when the power source becomes depleted. In an alternative embodiment, the power source 20 is located near the surface contact device. In yet another alternative embodiment, the power source 20 is replaceable. For example, the ink jet pen may comprise a door or hatch or other opening to allow for removal and replacement of the power source 20. In yet another exemplary embodiment, the power source is configured to be rechargeable. Various recharging mechanisms are known to one skilled in the art. For example, in one embodiment, the ink jet pen is adapted to have at least a portion of the ink jet pen inserted into a recharging apparatus, such as a cradle. In another embodiment, a cable can be attached to the ink jet pen to recharge the power source 20.

The foregoing description of the various embodiments and principles of the invention has been presented for the purposes of illustration and description. It is not intended to be exhaustive or to limit the invention to the precise forms disclosed. Many alternatives, modifications and variations will be apparent to those skilled in the art. For example, some principals of the invention may be used in different ink jet pen configurations. Moreover, although multiple inventive concepts have been presented, such aspects need not be utilized in combination, and various combinations of inventive aspects are possible in light of the various embodiments provided above. Accordingly, the above description is intended to embrace all possible alternatives, modifications, combinations, and variations that have been discussed or suggested herein, as well as all others that fall within the principals, spirit and broad scope of the invention as defined by the claims.

What is claimed:

1. A hand-held ink jet pen comprising:
an ink reservoir adapted to contain ink;
a printhead in fluid communication with the ink reservoir;
a power source;
a surface contact sensor, wherein the surface contact sensor is configured to send a signal to the printhead to allow ejection of ink when the surface contact sensor in contact with a surface; and
an override jetting button, wherein the jetting button is configured to allow ejection of ink from the ink jet pen without surface contact of the surface contact sensor.

2. The hand-held ink jet pen of claim 1, wherein the ink reservoir is removable.

3. The hand-held ink jet pen of claim 1, wherein the ink reservoir is adapted to connect to an auxiliary ink tank.

4. The hand-held ink jet pen of claim 1, further comprising a housing, wherein the housing is adapted to contain at least a portion of the power source and the ink reservoir.

5. The hand-held ink jet pen of claim 1, wherein the surface contact sensor comprises a ball point, wherein the ball point is adapted to activate a switch upon movement of the ink jet pen along a surface of a substrate.

6. Then hand-held ink jet pen of claim 1, wherein the override jetting button is configured to control the flow rate of ink ejected from the inkjet pen.

7. A hand-held ink jet pen comprising:
an ink reservoir adapted to contain ink;
a printhead in fluid communication with the ink reservoir;
a power source;
a surface contact sensor, wherein the surface contact sensor is configured to send a signal to the print head to allow ejection of ink when the surface contact sensor in contact with a surface; and
a removable printhead cap, wherein the printhead cap is configured to cover at least a portion of the printhead and minimize evaporation of ink through the printhead when the ink jet pen is not in use.

8. The hand-held ink jet pen of claim 7, wherein the printhead cap comprises an absorbing pad adapted to perform maintenance on the printhead.

9. The ink jet pen of claim 8, wherein the printhead cap further comprises an actuator adapted to place the absorbing pad in contact with the printhead.

10. The hand-held ink jet pen of claim 7, wherein the ink reservoir is removable.

11. The hand-held ink jet pen of claim 7, wherein the ink reservoir is adapted to connect to an auxiliary ink tank.

12. The hand-held ink jet pen of claim 7, further comprising a housing, wherein the housing is adapted to contain at least a portion of the power source and the ink reservoir.

13. The hand-held ink jet pen of claim 7, wherein the surface contact sensor comprises a ball point, wherein the ball point is adapted to activate a switch upon movement of the inkjet pen along a surface of a substrate.
